(19) United States
(12) Patent Application Publication
(10) Pub. No.: US 2026/0133460 A1
(43) Pub. Date: May 14, 2026

(54) BACKPLANE AND DISPLAY DEVICE

(71) Applicant: Sharp Display Technology Corporation, Kameyama City (JP)

(72) Inventors: Jun NISHIMURA, Kameyama City (JP); Masaki MAEDA, Kameyama City (JP); Yoshiharu HIRATA, Kameyama City, (JP); Hideki KITAGAWA, Kameyama City, (JP); Yoshihito HARA, Kameyama City, (JP); Hajime imal, Kameyama City, (JP)

(21) Appl. No.: 19/374,115

(22) Filed: Oct. 30, 2025

(30) Foreign Application Priority Data
Nov. 14, 2024 (JP) 2024-198832

(51) Int. Cl. G02F 1/16753; G02F 1/16756; G02F 1/1676

(52) U.S. Cl. CPC G02F 1/16753; G02F 1/16756; G02F 1/1676; G02F 2201/123; G02F 2202/28

(57) ABSTRACT

A backplane to be attached to an adhesive layer that is disposed on one surface of a display layer for displaying an image includes a pixel electrode disposed such that the adhesive layer is sandwiched between the display layer and the pixel electrode, and an insulating layer disposed between the pixel electrode and the adhesive layer.

### CROSS REFERENCE TO RELATED APPLICATION

This application claims priority from Japanese Patent Application No. 2024-198832 filed on Nov. 14, 2024. The entire contents of the priority application are incorporated herein by reference.

### TECHNICAL FIELD

The present technology described herein relates to a backplane and a display device in which leakage is less likely to occur in a pixel electrode.

### BACKGROUND

There has been known a backplane included in an electronic paper display, which is one kind of display devices. The backplane includes pixel electrodes and an adhesive layer disposed adjacent to the backplane. The adhesive layer includes pixel regions disposed adjacent to the pixel electrodes and at least one inter-pixel region disposed between two pixels of the backplane. The at least one inter-pixel region has a dielectric constant lower than that of the pixel regions and a volume resistivity higher than that of the pixel regions.

In such a backplane, the adhesive layer is directly attached to the pixel electrodes. Therefore, with a voltage applied to the pixel electrode being increased, the adhesive layer exceeds the dielectric strength and leakage may occur in the pixel electrode. If an obstacle having electric conductivity is attached to a surface of the adhesive layer or the pixel electrode, leakage may occur in the pixel electrode.

### SUMMARY

The technology described herein was made in view of the above circumstances. An object is to suppress occurrence of leakage in a pixel electrode.

(1) A backplane according to the technology described herein is to be attached to an adhesive layer that is disposed on one surface of a display layer for displaying an image. The backplane includes a pixel electrode disposed such that the adhesive layer is sandwiched between the display layer and the pixel electrode, and an insulating layer disposed between the pixel electrode and the adhesive layer.

(2) The backplane may further include, in addition to (1), a base and the pixel electrode may include pixel electrodes that are arranged at intervals on a surface of the base, and the insulating layer may cover the pixel electrodes and cover the surface of the base between the pixel electrodes.

(3) In the backplane, in addition to (1) or (2), the insulating layer may be made of material having resistance higher than that of the adhesive layer.

(4) A display device according to the technology described herein includes the backplane according to any one of (1) to (3), the display layer, and the adhesive layer.

(5) In the display device, in addition to (4), the display layer may be an electronic paper layer that includes microcapsules or microcups that include charged particles therein, and the pixel electrode may include pixel electrodes that overlap the microcapsules or the microcups, respectively.

(6) In the display device, in addition to (5), each of the microcapsules or each of the microcups may include the charged particles that exhibit different colors.

According to the technology described herein, leakage is less likely to occur in a pixel electrode.

### BRIEF DESCRIPTION OF THE DRAWINGS

FIG. 1 is a plan view of a backplane of an electronic paper display according to a first embodiment.

FIG. 2 is a cross-sectional view illustrating a cross-sectional configuration of a display area of the electronic paper display according to the first embodiment.

FIG. 3 is a plan view illustrating a planar configuration of the display area of the backplane of the first embodiment.

FIG. 4 is a cross-sectional view of the electronic paper layer and the backplane that are not attached to each other.

FIG. 5 is a cross-sectional view illustrating a cross-sectional configuration of a display area of an electronic paper display according to a second embodiment.

### DETAILED DESCRIPTION

### First Embodiment

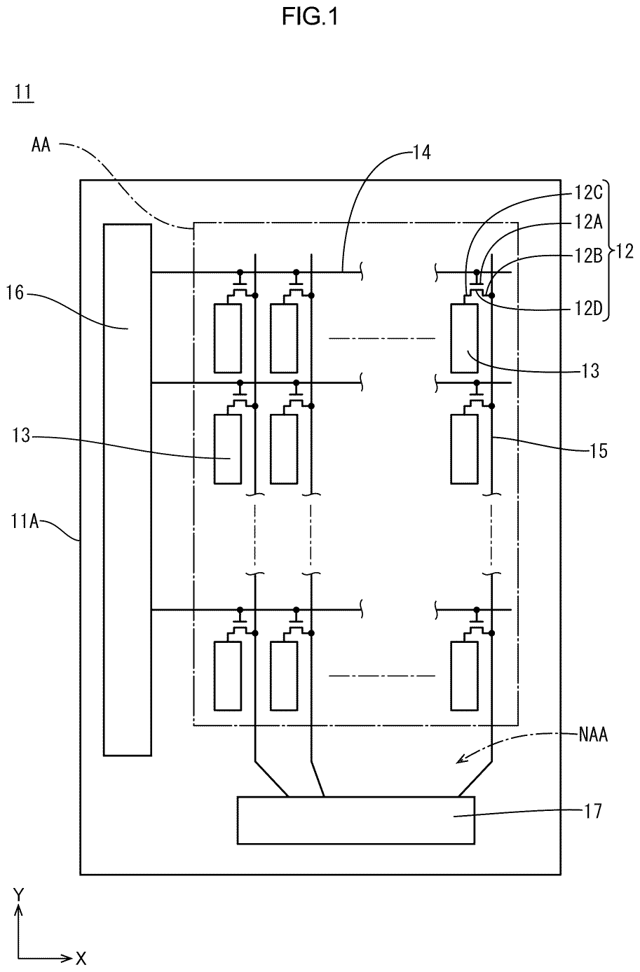

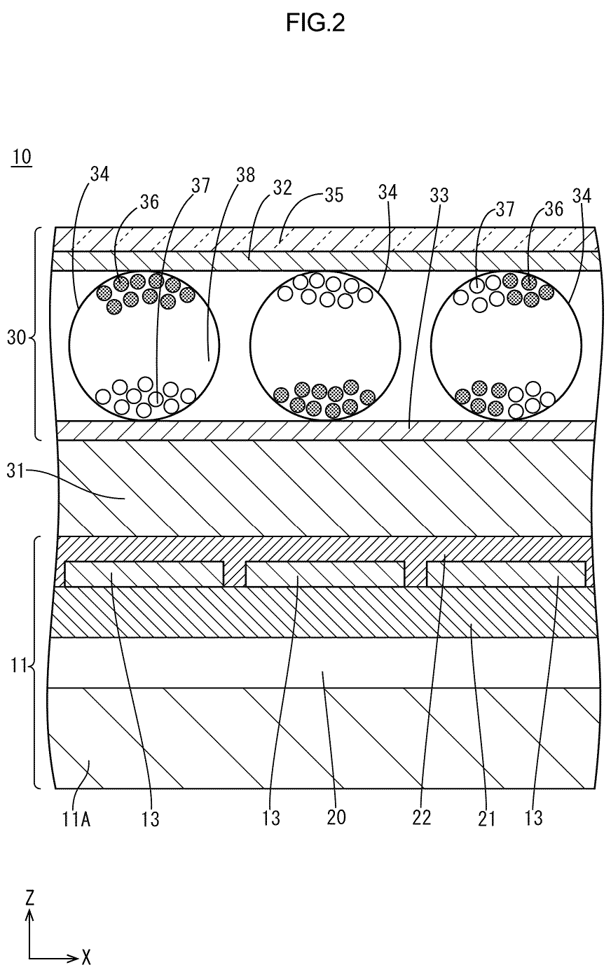

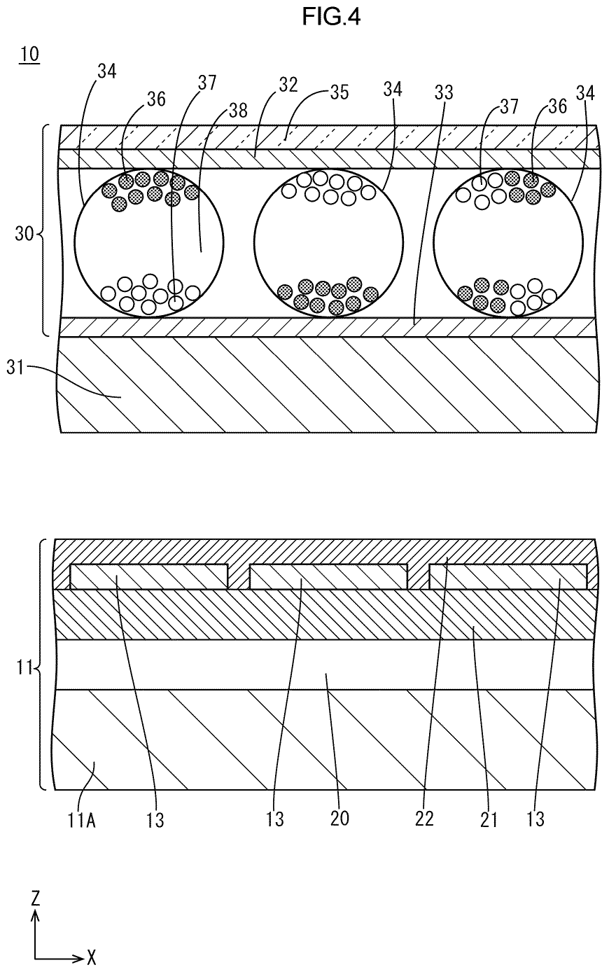

A first embodiment will be described with reference to FIGS. 1 to 4. An electronic paper display 10 (a display device, EPD) of the first embodiment will be described. X-axes, Y-axes, and Z-axes may be present in the drawings. The axes in each drawing correspond to the respective axes in other drawings. An upper side and a lower side in FIGS. 2 and 4 correspond to a front side and a back side of the electronic paper display 10, respectively.

The electronic paper display 10 of this embodiment is a microcapsule-based electrophoretic display. As illustrated in FIG. 1, the electronic paper display 10 includes a backplane 11 having a vertically long rectangular shape. As illustrated in FIG. 1, a middle section of a surface of the backplane 11 is configured as a display area AA in which images are displayed. An outer section in a frame shape surrounding the display area AA in the surface of the backplane 11 is configured as a non-display area NAA in which images are not displayed.

The backplane 11 has a configuration similar to that of an active matrix substrate included in a liquid crystal display device. As illustrated in FIG. 1, thin film transistors (TFTs) 12 (transistors, switching components) and pixel electrodes 13 are arranged in the display area AA of the backplane. The TFTs 12 and the pixel electrodes 13 are arranged at intervals in a matrix (rows and columns) along the X-axis direction and the Y-axis direction. Gate lines 14 (scanning lines) and source lines 15 (image lines, signal lines) are routed perpendicular to each other (with crossing) to surround the TFTs 12 and the pixel electrodes 13. The gate lines 14 extend along the X-axis direction and are arranged at intervals in the Y-axis direction. The source lines 15 extend along the Y-axis direction and are arranged at intervals in the X-axis direction. The TFT 12 includes a gate electrode 12A that is connected to the gate line 14, a source electrode 12B that is connected to the source line 15, a drain electrode 12C that is connected to the pixel electrode 13, and a semiconductor section 12D that is connected to the source electrode 12B and the drain electrode 12C and made of semiconductor material. The semiconductor material of the semiconductor section 12D may be oxide semiconductor material. The TFTs 12 are driven based on scan signals supplied to the gate electrodes 12A through the gate lines 14. The scan signals include a potential higher than threshold voltage of the TFT 12. Through the driving of the TFT 12, a channel section is created in the semiconductor section 12D and electrons move between the source electrode 12B and the drain electrode 12C via the channel section. Therefore, a potential related to the image signal (data signal) that is supplied to the source electrode 12B through the source line 15 is supplied to the drain electrode 12C via the semiconductor section 12D. As a result, the pixel electrode 13 is charged at the potential related to the pixel signal.

As illustrated in FIG. 1, a gate circuit 16 and a source driver 17 are disposed in the non-display area of the backplane 11. The gate circuit 16 is disposed adjacent to one side (a left side in FIG. 1) of the display area AA with respect to the X-axis direction. The gate circuit 16 is disposed in a belt-shaped area extending along the Y-axis direction. The gate lines 14 have extending portions that are disposed in the non-display area NAA and are connected to the gate circuit 16. The gate circuit 16 is configured to supply scanning signals to the gate lines 14. The gate circuit 16 is monolithically fabricated on the backplane 11. The gate circuit 16 is a gate driver monolithic (GDM) circuit. The gate circuit 16 is supplied with various kinds of signals that are transferred from a flexible substrate that is connected to the backplane 11.

As illustrated in FIG. 1, the source driver 17 is disposed adjacent to one side (a lower side in FIG. 1) of the display area AA with respect to the Y-axis direction. The source driver 17 has a laterally long rectangular plan view shape. The source lines 15 have extending portions that are disposed in the non-display area NAA and are connected to the source driver 17. The source driver 17 is configured to supply image signals to the source lines 15. The source driver 17 is an LSI chip that includes a driver circuit therein. The source driver 17 is mounted on the backplane 11. The source driver 17 processes various kinds of signals that are transferred from the flexible substrate that is connected to the backplane 11.

A cross-sectional configuration of the display area AA of the electronic paper display 10 will be described with reference to FIG. 2. In FIG. 2, the TFTs 12, the gate lines 14, and the source lines 15 are simply illustrated as a pixel circuit portion 20. As illustrated in FIG. 2, the electronic paper display 10 includes the backplane 11, an electronic paper layer 30 (a display layer), and an adhesive layer 31. The electronic paper layer 30 is disposed on the front side of the backplane 11 to overlap the backplane 11. The adhesive layer 31 is disposed on a back side (one side) surface of the electronic paper layer 30 for bonding the backplane 11 and the electronic paper layer 30. The electronic paper layer 30 includes two films 32, 33, microcapsules 34 disposed between the two films 32, 33, and a transparent electrode 35 (an opposed electrode). The transparent electrode 35 is disposed on a front side of the film 32, which is a front one (upper one in FIG. 2) of the two films. The electronic paper layer 30 may be referred to as a front panel laminate (FPL).

As illustrated in FIG. 2, the adhesive layer 31 is disposed on a back side of the film 33, which is a back side one (lower one in FIG. 2) of the two films. The adhesive layer 31 includes at least one of adhesive agent and bonding agent. For instance, a double-sided adhesive tape that includes a base (a support member) and adhesive agent or bonding agent disposed on front and back surfaces of the base may be used as the adhesive layer 31. With the adhesive layer 31, the electronic paper layer 30 and the backplane 11 are integrally configured as one component such that the electronic paper layer 30 is disposed on the front side of the backplane 11. The pixel electrodes 13 included in the backplane 11 and the electronic paper layer 30 sandwich the adhesive layer 31 therebetween.

A detailed configuration of the electronic paper layer 30 will be described. The films 32, 33 of the electronic paper layer 30 are made of transparent synthetic resin material. As illustrated in FIG. 2, the films 32, 33 are disposed to be opposed to each other with having a predefined distance therebetween with respect to the Z-axis direction. The microcapsules 34 are arranged in a single layer between the films 32, 33. The microcapsules 34 are disposed to overlap one pixel electrode 13 of the backplane 11. The microcapsule 34 includes at least black particles 36 exhibiting black and white particles 37 exhibiting white as charged particles. The black particles 36 are carbon black particles that are negatively charged. The white particles 37 are titanium oxide particles that are positively charged. The microcapsule 34 includes insulating fluid 38 in which the black particles 36 and the white particles 37 are dispersed. An example of the insulating fluid 38 is silicone oil. The transparent electrode 35 is made of transparent electrode material such as indium tin oxide (ITO). The transparent electrode 35 is disposed in a solid manner to extend at least in an entire area of the display area AA and overlaps all the pixel electrodes 13 included in the backplane 11. External light entering the electronic paper layer 30 from the front side passes through the films 32, 33 and the transparent electrode 35.

As illustrated in FIG. 2, the backplane 11 includes a base substrate 11A made of synthetic resin or glass. The pixel circuit portion 20 including the TFTs 12, the gate lines 14, and the source lines 15 are disposed in the display area AA of the base substrate 11A. A base insulating layer 21 (a base) is disposed in a layer upper than the pixel circuit portion 20. The base insulating layer 21 is made of an inorganic material such as silicon nitride (SiN_{X}) and silicon oxide (SiO₂) or an organic material such as acrylic resin (PMMA). The pixel electrodes 13 are disposed in a layer upper than the base insulating layer 21. The pixel electrodes 13 are made of transparent electrode material such as ITO or metal material that is not transparent.

As illustrated in FIG. 2, the pixel electrodes 13 are charged at a predefined potential or not charged according to the operation of the pixel circuit portion 20. Then, a potential difference according to the potential of each pixel electrode 13 is created between the pixel electrode 13 and the transparent electrode 35. With a negative electric field relative to the transparent electrode 35 being applied to one of the pixel electrodes 13 (the pixel electrode 13 on the left end in FIG. 2), the negatively charged black particles 36 move to the front side portion of the microcapsule 34 due to a repulsion force. The positively charged white particles 37 move to the back side portion of the microcapsule 34 due to an attraction force. As a result, the light entering the electronic paper layer 30 from the front side is absorbed by the black particles 36 in the front side portion of the microcapsule 34. Accordingly, the microcapsule 34, which is disposed on the left side in FIG. 2, exhibits black. Thus, the microcapsule 34 overlapping the pixel electrode 13 to which a negative electric field is applied performs black display.

On the other hand, with a positive electric field relative to the transparent electrode 35 being applied to another one of the pixel electrodes 13 (the pixel electrode 13 in a middle in FIG. 2), the positively charged white particles 37 move to the front side portion of the microcapsule 34 due to a repulsion force. The negatively charged black particles 36 move to the back side portion of the microcapsule 34 due to an attraction force. As a result, the light entering the electronic paper layer 30 from the front side is reflected by the white particles 37 in the front side portion of the microcapsule 34. Accordingly, the microcapsule 34, which is disposed in a middle in FIG. 2, exhibits white. Thus, the microcapsule 34 overlapping the pixel electrode 13 to which a positive electric field is applied performs white display.

With other one of the pixel electrodes 13 (the pixel electrode 13 on the right end in FIG. 2) being not charged and no electric filed being applied to the pixel electrode 13, both of the black particles 36 and the white particles 37 are in the front side portion and in the back side portion of the microcapsule 34. The light entering the electronic paper layer 30 from the front side is absorbed by the black particles 36 in the front side portion of the microcapsule 34 and reflected by the white particles 37 in the front side portion of the microcapsule 34. Accordingly, the microcapsule 34, which is disposed on the right end in FIG. 2, exhibits gray. Thus, the microcapsule 34 overlapping the pixel electrode 13 to which no electric field is applied performs gray display.

With the potential of each of the pixel electrodes 13 being controlled by the pixel circuit portion 20, the color exhibited by the microcapsule 34 overlapping each pixel electrode 13 can be controlled. Accordingly, gray scale image display of multiple gradation (sixteen gradation, for instance) can be performed.

As illustrated in FIG. 2, the backplane 11 of this embodiment includes an insulating layer 22 between the pixel electrodes 13 and the adhesive layer 31. The insulating layer 22 is made of an inorganic material such as silicon nitride (SiN_{X}). The thickness of the insulating layer 22 is about 200 nm, for instance. The insulating layer 22 is disposed in a layer upper than the pixel electrodes 13 and covers the pixel electrodes 13. The insulating layer 22 is in an uppermost layer of the backplane 11 and the adhesive layer 31 is bonded to the surface of the insulating layer 22.

In the electronic paper display 10 of this embodiment, the voltage applied to the pixel electrodes 13 is about ±30V and is higher than the voltage (about ±10V) applied to the pixel electrodes of a liquid crystal panel. Therefore, the adhesive layer 31 may exceed the dielectric strength thereof. In this respect, the insulating layer 22 is disposed between the pixel electrodes 13 and the adhesive layer 31 in this embodiment. Therefore, even if the adhesive layer 31 exceeds the dielectric strength, leakage is less likely to occur in the pixel electrode 13. Furthermore, even if an electrically conductive obstacle may be attached to the surface of the adhesive layer 31 or the insulating layer 22, the obstacle is less likely to be contacted with the pixel electrode 13 because of the insulating layer 22. Accordingly, leakage is less likely to occur in the pixel electrode 13. With leakage being less likely to occur in the pixel electrode 13, display quality of the electronic paper display 10 is improved.

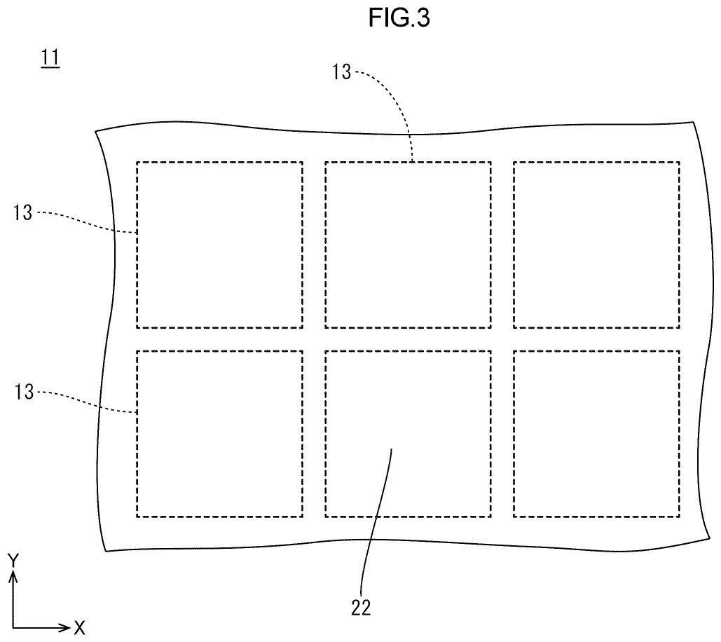

As illustrated in FIG. 3, the pixel electrodes 13 that are covered by the insulating layer 22 are arranged at intervals in a matrix within the surface area of the base insulating layer 21. The entire area of each of the pixel electrodes 13 is covered by the insulating layer 22. Furthermore, as illustrated in FIGS. 2 and 3, portions of the base insulating layer 21 that are between the pixel electrodes 13 are covered by the insulating layer 22. Thus, each of the pixel electrodes 13 is covered by the insulating layer 22 and the insulating layer 22 is disposed on the surface of the base insulating layer 21 between the adjacent pixel electrodes 13. Therefore, leakage is less likely to occur in each of the pixel electrodes 13.

The insulating layer 22 is made of material having resistance higher than that of the adhesive layer 31. Even if the voltage applied to the pixel electrode 13 increases, the insulating layer 22 is less likely to exceed the dielectric strength thereof. Therefore, leakage is less likely to occur in the pixel electrode 13.

The method of producing the electronic paper display 10 having the above configuration will be described. First, the backplane 11 and the electronic paper layer 30 are produced. The adhesive layer 31 is disposed on the back surface of the film 33 of the electronic paper layer 30. Then, as illustrated in FIG. 4, the electronic paper layer 30 is arranged such that the adhesive layer 31 is opposite the insulating layer 22 of the backplane 11 and the electronic paper layer 30 is attached to the backplane 11. Accordingly, the adhesive layer 31 is bonded to the insulating layer 22 and the electronic paper layer 30 is fixed to the backplane 11.

As previously described, the adhesive layer 31 that is disposed on one surface of the electronic paper layer 30 (the display layer), which is for displaying an image, is bonded to the backplane 11. The backplane 11 of this embodiment includes the pixel electrodes 13 and the insulating layer 22. The pixel electrodes 13 are arranged such that the adhesive layer 31 is disposed between the electronic paper layer 30 and the pixel electrodes 13. The insulating layer 22 is disposed between the pixel electrodes 13 and the adhesive layer 31.

with the adhesive layer 31 being bonded to the backplane 11, the electronic paper layer 30 is integrally disposed on the backplane 11. With a voltage being applied to the pixel electrodes 13, displaying of images is performed with the electronic paper layer 30. Even if the voltage applied to the pixel electrodes 13 increases and the adhesive layer 31 exceeds the dielectric strength thereof, leakage is less likely to occur in the pixel electrodes 13 since the insulating layer 22 is disposed between the pixel electrodes 13 and the adhesive layer 31. Furthermore, even if an electrically conductive obstacle is attached to the surface of the adhesive layer 31 or the insulating layer 22, the obstacle is less likely to be contacted with the pixel electrode 13 because of the insulating layer 22. Accordingly, leakage is less likely to occur in the pixel electrode 13.

The pixel electrodes 13 are arranged at intervals on the surface of the base insulating layer 21, which is a base. The insulating layer 22 covers the pixel electrodes 13 and covers the base insulating layer 21 between the adjacent pixel electrodes 13. Each of the pixel electrodes 13 is covered by the insulating layer 22 and the insulating layer 22 is disposed on the surface of the base insulating layer 21 between the adjacent pixel electrodes 13. With such a configuration, leakage is further less likely to occur in each of the pixel electrodes 13.

The insulating layer 22 is made of material having resistance higher than that of the adhesive layer 31. Even if the voltage applied to the pixel electrode 13 increases, the insulating layer 22 is less likely to exceed the dielectric strength thereof. Therefore, leakage is less likely to occur in the pixel electrode 13.

The electronic paper display 10 (the display device) of this embodiment includes the backplane 11, the electronic paper layer 30, and the adhesive layer 31. With such an electronic paper display 10, leakage is less likely to occur in the pixel electrode 13 and display quality of the electronic paper display 10 is improved.

The electronic paper layer 30, which is the display layer, includes the microcapsules 34 each of which includes the black particles 36 and the white particles 37 as the charged particles. The pixel electrodes 13 are disposed to overlap the microcapsules 34. The black particles 36 and the white particles 37, which are the charted particles, move within the microcapsules 34 according to the voltage applied to the pixel electrodes 13. Accordingly, an image is displayed with the electronic paper layer 30.

### Second Embodiment

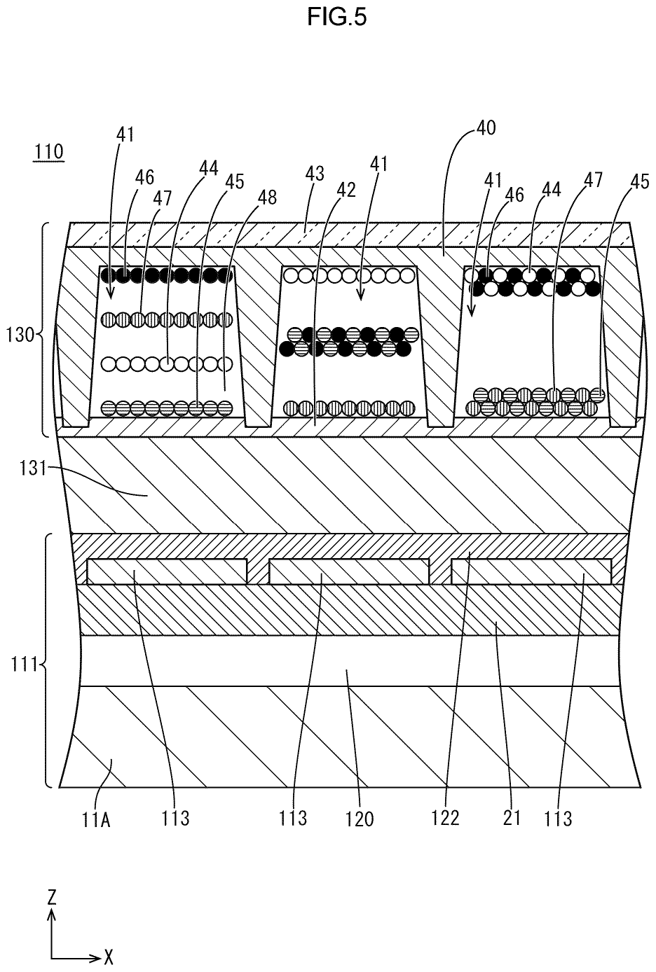

A second embodiment will be described with reference to FIG. 5. In the second embodiment, an electronic paper layer 130 includes microcups 41 and displaying of color images is performed. Configurations, operations, and effects same as those of the first embodiment will not be described.

An electronic paper display 110 of this embodiment is a microcup-based electrophoretic display. As illustrated in FIG. 5, the electronic paper layer 130 includes a base member 40 that includes the microcups 41, a sealing member 42 disposed on the base member 40 to seal the microcups 41, and a transparent electrode 43 (the opposed electrode) that is disposed on the front side of the base member 40. The base member 40 is made of transparent synthetic resin material and includes the micrucups 41 that open toward the back side. Specifically, the base member 40 includes partition walls that are formed in a grid in a plan view. Spaces are defined by the partition walls and the partition walls defining the spaces are configured as the microcups 41. The microcups 41 are arranged in a matrix in a plan view within the surface area of the base member 40. With the back surface of the base member 40 being embossed, the microcups 41 are formed in the back surface of the base member 40 such that the space of a predefined depth is formed therein.

The microcups 41 overlap pixel electrodes 113 of a backplane 111. At least white particles 44 exhibiting white, yellow particles 45 exhibiting yellow, blue particles 46 exhibiting blue, and red particles 47 exhibiting red are in each of the microcups 41 as the charged particles. The white particles 44 and the yellow particles 45 are negatively charged, for instance. The blue particles 46 and the red particles 47 are positively charged, for instance. The microcups 41 includes insulating fluid 48 therein. The particles 44-47 are dispersed in the insulating fluid 48. An example of the insulating fluid 48 is silicone oil.

The sealing member 42 is a sheet member and disposed on the back side of the base member 40. The sealing member 42 collectively covers the microcups 41 that open toward the back side and is disposed on the base member 40. Accordingly, the particles 44-47 and the insulating fluid 48 are enclosed in each microcup 41. An adhesive layer 131 is disposed on the sealing member 42 on the back side thereof. The transparent electrode 43 is similar to the transparent electrode 35 of the first embodiment.

A potential difference is created between the pixel electrodes 113 and the transparent electrode 43 according to the potential applied to each pixel electrode 113 from a pixel circuit portion 120. With the particles 44-47 moving within the microcup 41 according to the potential difference, displaying of corresponding colors is performed. For instance, in the microcup 41 on the left end in FIG. 5, the blue particles 46 and the red particles 47 are in the front portion of the microcup 41 and black display is performed. In the microcup 41 disposed in a middle in FIG. 5, the white particles 44 are in the front portion of the microcup 41 and white display is performed. In the microcup 41 on the right end in FIG. 5, the white particles 44 and the blue particles 46 are in the front portion of the microcup 41 and blue display is performed. Furthermore, by controlling the potential of the pixel electrode 13 to move predefined particles to the front portion of the microcup 41, red display, yellow display, and green display can be performed. Displaying of different colors (six colors in this embodiment) with the microcups 41 is performed and accordingly, the electronic paper display 110 displays a color image.

In the electronic paper display 110 that displays color images, voltage applied to the pixel electrodes 113 may increase higher than that of the first embodiment. Even in such a case, in this embodiment, the insulating layer 122 is disposed between the pixel electrodes 113 and the adhesive layer 131 and therefore, even if the adhesive layer 131 exceeds the dielectric strength thereof, leakage is less likely to occur in the pixel electrode 113. Accordingly, display quality of the electronic paper display 110 is improved.

As previously described, according to this embodiment, the electronic paper layer 130 includes the microcups 41 and each of the microcups 41 includes charged particles that exhibit different colors such as the white particles 44, the yellow particles 45, the blue particles 46, and the red particles 47. According to the voltage applied to the pixel electrodes 113, the white particles 44, the yellow particles 45, the blue particles 46, and the red particles 47, which are the charged particles exhibiting different colors, are moved. Thus, a predefined color image is displayed on the electronic paper layer 130. To display such a color image, the voltage applied to the pixel electrodes 113 tends to increase; however, leakage is less likely to occur in the pixel electrodes 113 because of the insulating layer 122 and good display quality can be maintained.

### Other Embodiments

The technology described herein is not limited to the embodiments described above and illustrated by the drawings. For example, the following embodiments will be included in the technical scope of the present technology.
(1) The material and the thickness of the insulating layer 22, 122 may be altered as appropriate from those described above. The material of the insulating layer 22, 122 may be silicon oxide (SiO₂), an organic material such as acrylic resin (PMMA, for instance), or photoresist material such as negative-type photoresist material.
(2) The insulating layer 22, 122 may not be necessarily a single layer film but may be a multilayer film. Specifically, the insulating layer 22, 122 may have a two-layer structure including a lower layer insulating layer that is contacted with the pixel electrodes 13, 113, and an upper layer insulating layer that is contacted with the adhesive layer 31, 131 or may have a multilayered structure including three layers or more. The multilayered structure may include the lower layer insulating layer, the upper layer insulating layer, and an intermediate insulating layer. In such structures, the lower layer insulating layer that is contacted with the pixel electrodes 13, 113 may be made of material that has high adhesion with respect to the adhesive layer 31, 131.
(3) The microcapsules 34 or the microcups 41 may overlap one pixel electrode 13, 113.
(4) The pixel electrodes 13, 113 may overlap one microcapsule 34 or the microcup 41.
(5) In the configuration of the first embodiment, in addition to gray scale images, black-and-white images may be displayed.
(6) In the configuration of the first embodiment, the electronic paper layer 30 may include the microcups 41 of the second embodiment.
(7) In the configuration of the second embodiment, the electronic paper layer 130 may include the microcapsules 34 of the first embodiment. In such a configuration, with the microcapsule 34 including several kinds of charged particles exhibiting different colors, color images can be displayed. In the electronic paper layer 130 including the microcapsules 34, color filters may be disposed on the transparent electrode 35 and light is filtered by the color filters to display color images.
(8) The electronic paper layer 30, 130 may be an electrophoretic display type (such as an In-plane type) other than the microcapsule type and the microcup type.
(9) The electronic paper layer 30, 130 may be an electronic powder fluid display type other than the electrophoretic display type.
(10) Any display layer other than the electronic paper layer 30, 130 may be used.
(11) The material of the semiconductor film used for the backplane 11, 111 may be polysilicon or amorphous silicon.
(12) Two gate circuits may be disposed to sandwich the display area AA. Instead of the gate circuit 16, a gate driver similar to the source driver 17 may be mounted on the backplane 11, 111.
(13) The source driver 17 may be mounted on a flexible substrate that is mounted on the backplane 11, 111 with a chip on film (COP) technology.
(14) A plan view shape of the electronic paper display 10, 110 may be a laterally long rectangle, a square, a circle, a semicircle, a vertically long rectangle, an oval, and a trapezoid.

1. A backplane to be attached to an adhesive layer that is disposed on one surface of a display layer for displaying an image, the backplane comprising:
a pixel electrode disposed such that the adhesive layer is sandwiched between the display layer and the pixel electrode; and
an insulating layer disposed between the pixel electrode and the adhesive layer.

2. The backplane according to claim 1, further comprising a base, wherein
the pixel electrode includes pixel electrodes that are arranged at intervals on a surface of the base, and
the insulating layer covers the pixel electrodes and covers the surface of the base between the pixel electrodes.

3. The backplane according to claim 1, wherein the insulating layer is made of material having resistance higher than that of the adhesive layer.

4. A display device comprising:
the backplane according to claim 1;
the display layer; and
the adhesive layer.

5. The display device according to claim 4, wherein
the display layer is an electronic paper layer that includes microcapsules or microcups that include charged particles therein, and
the pixel electrode includes pixel electrodes that overlap the microcapsules or the microcups, respectively.

6. The display device according to claim 5, wherein each of the microcapsules or each of the microcups includes the charged particles that exhibit different colors.
